(19) United States
(12) Patent Application Publication
(10) Pub. No.: US 2021/0302179 A1
(43) Pub. Date: Sep. 30, 2021

(54) SERVER DEVICE, CONTROL DEVICE, PROGRAM, VEHICLE, AND OPERATION METHOD OF INFORMATION PROCESSING SYSTEM

(71) Applicant: Toyota Jidosha Kabushiki Kaisha, Toyota-shi Aichi-ken (JP)

(72) Inventors: Tsuyoshi Andou, Toyota-shi (JP); Akitoshi Jikumaru, Nisshin-shi (JP); Ryosuke Kobayashi, Nagakute-shi (JP); Tomokazu Maya, Nagoya-shi (JP); Masatoshi Hayashi, Nisshin-shi (JP)

(73) Assignee: Toyota Jidosha Kabushiki Kaisha, Toyota-shi Aichi-ken (JP)

(21) Appl. No.: 17/212,358

(22) Filed: Mar. 25, 2021

(30) Foreign Application Priority Data
Mar. 30, 2020 (JP) 2020-061324

(51) Int. Cl. G01C 21/34; G06K 9/00; G08G 1/00

(52) U.S. Cl. CPC G01C 21/3438; G01C 21/3476; G08G 1/202; G06K 9/00805

(57) ABSTRACT

A server device includes a communication unit and a control unit configured to send and receive information to and from another device via the communication unit. The control unit is configured to detect an object of interest of a spectator based on a state of the spectator detected during execution of an event and is configured to send a notification to prompt to ride in a vehicle to a plurality of terminal devices respectively used by a plurality of spectators. The vehicle is a vehicle assigned to the plurality of spectators sharing the object of interest.

### CROSS-REFERENCE TO RELATED APPLICATION

This application claims priority to Japanese Patent Application No. 2020-061324 filed on Mar. 30, 2020, incorporated herein by reference in its entirety.

### BACKGROUND

### 1. Technical Field

The present disclosure relates to a server device, a control device, a program, a vehicle, and an operation method of an information processing system.

### 2. Description of Related Art

In the so-called ride sharing in which a plurality of users shares one vehicle, it is essential that the users be compatible with each other to ensure a comfortable ride. To address this problem, various techniques have been proposed to support good compatibility or combination between users. For example, Japanese Unexamined Patent Application Publication No. 2014-146261 (JP 2014-146261 A) discloses a system in which the attributes of users are stored in advance and the users are combined based on the attributes.

### SUMMARY

In ride sharing, there is room for increasing the fun of riding.

The present disclosure provides a server device and so on that can increase the fun of ride sharing.

A first aspect of the present disclosure relates to a server device including a communication unit and a control unit. The control unit is configured to send and receive information to and from another device via the communication unit. The control unit is configured to detect an object of interest of a spectator based on a state of the spectator detected during execution of an event and is configured to send a notification to prompt to ride in a vehicle to a plurality of terminal devices respectively used by a plurality of spectators. The vehicle is a vehicle assigned to the plurality of spectators sharing the object of interest.

A second aspect of the present disclosure relates to a control device mounted on a vehicle. The control device is configured to send and receive information to and from a server device and, at the same time, to control the vehicle. When an instruction to move to a meeting place of a plurality of spectators is sent from the server device, the control device is configured to control the vehicle to move to the meeting place. The server device is configured to detect an object of interest of a spectator based on a state of the spectator detected during execution of an event and is configured to send a notification to prompt to ride in a vehicle to a plurality of terminal devices respectively used by a plurality of spectators. The plurality of spectators shares the object of interest. The vehicle is assigned to the plurality of spectators.

A third aspect of the present disclosure relates to an operation method of an information processing system including a server device and a vehicle. The vehicle communicates with the server device. The operation method includes the server device detecting an object of interest of a spectator based on a state of the spectator detected during execution of an event, sending a notification to prompt to ride in a vehicle to a plurality of terminal devices respectively used by a plurality of spectators, and sending an instruction to move to a meeting place of the plurality of spectators to the vehicle; and the vehicle moving to the meeting place. The plurality of spectators shares the object of interest. The vehicle is assigned to the plurality of spectators.

According to the server device and so on disclosed in the present disclosure, the fun of ride sharing can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information processing system;

FIG. 2 is a diagram showing a configuration example of a server device;

FIG. 3 is a diagram showing a configuration example of a terminal device;

FIG. 4 is a diagram showing a configuration example of a vehicle;

FIG. 5 is a diagram showing a configuration example of a capturing device;

FIG. 6 is a sequence diagram showing an operation example of the information processing system; and

FIG. 7 is a sequence diagram showing another operation example of the information processing system.

### DETAILED DESCRIPTION OF EMBODIMENTS

An embodiment will be described below.

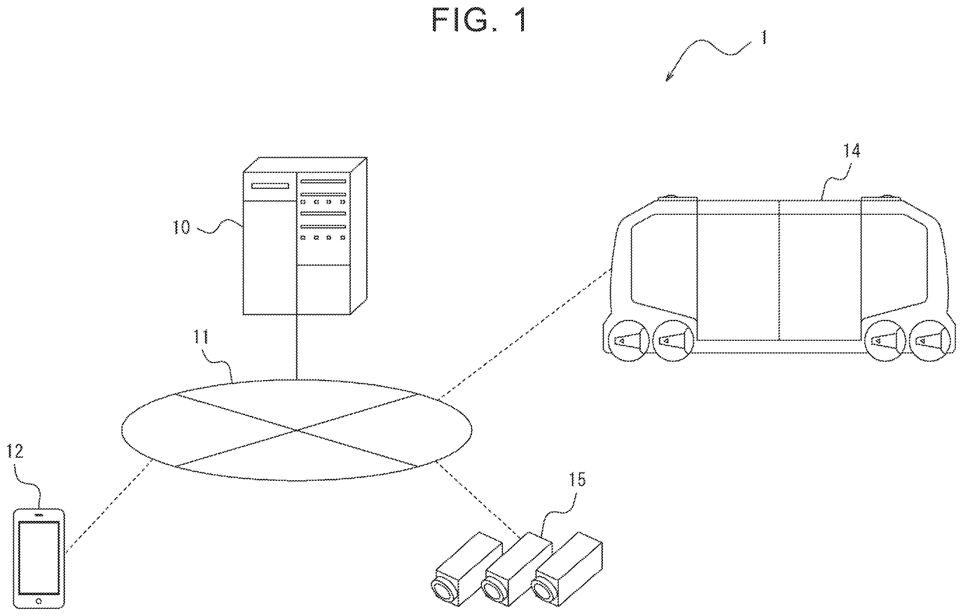

FIG. 1 is a diagram showing a configuration example of an information processing system in one embodiment. An information processing system 1 includes a server device 10, a terminal device 12, a vehicle 14, and a capturing device 15 that are connected to each other via a network 11 so that they can communicate with each other. The server device 10 is a computer. The terminal device 12 is, for example, a portable information terminal device such as a smartphone and a tablet terminal device. The terminal device 12 may also be a personal computer. The vehicle 14 is a multipurpose vehicle that allows a plurality of users to share a ride. The capturing device 15 is one or more cameras and their control devices. The network 11 is, for example, the Internet, but includes an ad hoc network, a LAN, a metropolitan area network (MAN), another network, or a combination of any of them. The number of units of each component included in the information processing system 1 may be larger than that shown in FIG. 1.

The information processing system 1 helps increase the fun of ride sharing when spectators of an event, such as sports, music, and theater, share a ride. The server device 10 acquires the information on the state of a spectator during execution of an event at an event site facility. The information on the state of a spectator is, for example, the captured image of the spectator captured by the capturing device 15 provided in the event site. In addition, the server device 10 acquires the captured image of the event from the capturing device 15. Then, based on the captured image of the spectator and the captured image of the event, the server device 10 detects the object of interest of the spectator in the event. After that, to a plurality of terminal devices 12 respectively used by a plurality of spectators who shares the object of interest, the server device 10 sends a notification to prompt to ride in the vehicle 14 that is assigned to the plurality of spectators. The notification to prompt to ride in the vehicle includes the information on the meeting place for a ride in the vehicle 14. On the other hand, the server device 10 sends to the vehicle 14 an instruction to move to the meeting place. In response to this instruction, the vehicle 14 moves to the meeting place. The spectator who uses the terminal device 12 recognizes his/her own object of interest and the meeting place for riding in the assigned vehicle 14, moves to the meeting place, rides in the vehicle 14 that has arrived at the meeting place, and then moves to the destination. At that time, since the spectators who share the object of interest can share a ride, it is highly likely that the spectators who share the ride will be compatible with each other. Good compatibility among the plurality of spectators allows the spectators to enjoy the conversation about the event among themselves, making it possible to increase the fun of ride sharing. In addition, the server device 10 causes the vehicle 14 to present content, such as video/voice related to the common object of interest, to the ride-sharing spectators. Providing content that can be enjoyed by the plurality of spectators who share the object of interest in this way further increase the fun of ride sharing.

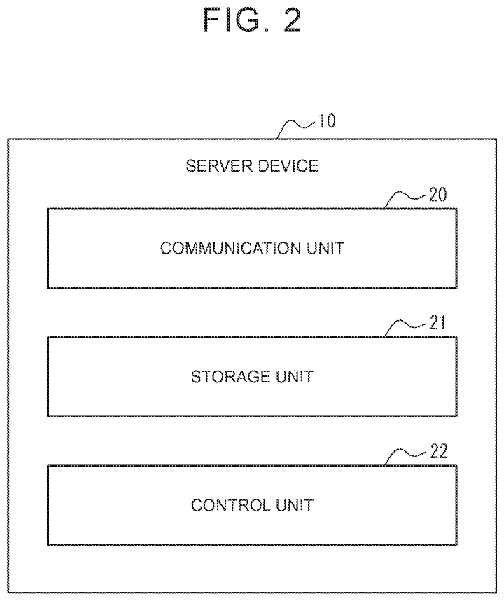

FIG. 2 shows a configuration example of the server device 10. The server device 10 includes a communication unit 20, a storage unit 21, and a control unit 22. The server device 10 may communicate and cooperate with another server device with an equivalent configuration for performing operation in this embodiment.

The communication unit 20 includes communication modules compatible with one or more wired or wireless LAN standards for connection to the network 11. In this embodiment, the server device 10 is connected to the network 11 via the communication unit 20 to communicate information with other devices over the network 11.

The storage unit 21 includes, for example, a semiconductor memory, a magnetic memory, or an optical memory. The storage unit 21 functions, for example, as a main storage device, an auxiliary storage device, or a cache memory. The storage unit 21 stores any information and the control/processing programs used for the operation of the server device 10.

The control unit 22 includes, for example, one or more general-purpose processors such as a central processing unit (CPU) or one or more dedicated processors specialized for specific processing. Instead of processors, the control unit 22 may also include one or more dedicated circuits such as a field-programmable gate array (FPGA) or an application specific integrated circuit (ASIC). The control unit 22 performs operation according to the control/processing programs, or performs operation according to the operation procedure implemented as a circuit, to comprehensively control the operation of the server device 10. The control unit 22 sends and receives various types of information to and from the terminal device 12 and the vehicle 14 via the communication unit 20 for performing the operation of the embodiment.

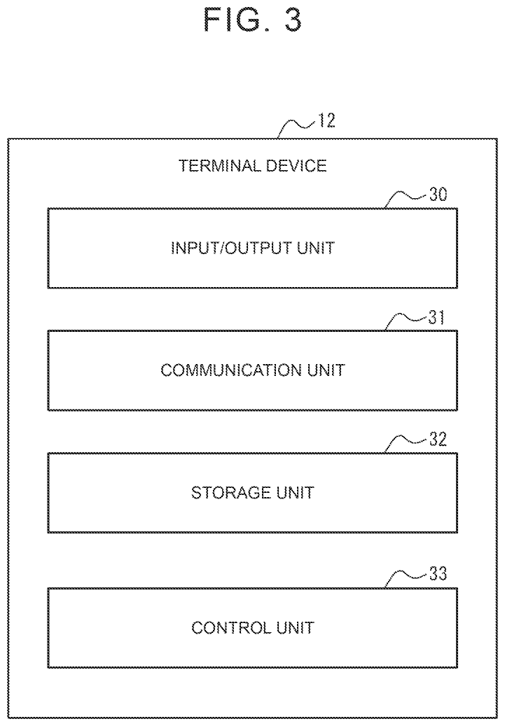

FIG. 3 shows a configuration example of the terminal device 12. The terminal device 12 is an information terminal device such as a smartphone, a tablet terminal device, or a personal computer. The terminal device 12 includes an input/output unit 30, a communication unit 31, a storage unit 32, and a control unit 33.

The input/output unit 30 includes an input interface that detects a user input and sends the detected input information to the control unit 33. The input interface is any input interface including, for example, physical keys, capacitive keys, a touch screen integrated with a panel display, various pointing devices, a microphone that receives a voice input, or a camera that captures a captured image or an image code. In addition, the input/output unit 30 includes an output interface that outputs the information generated by the control unit 33, or the information received from other devices, to the user. The output interface is any output interface including, for example, an external or built-in display that outputs the information as an image/video, a speaker that outputs the information as a voice, or a connection interface for connection to an external output device.

The communication unit 31 includes communication modules compatible with the wired or wireless LAN standard, modules compatible with a mobile communication standard such as the 4th generation (4G) standard or the 5th generation (5G) standard, and the GPS receiving module. The terminal device 12 is connected to the network 11 by the communication unit 31 via a nearby router or a mobile communication base station for communicating information with other devices over the network 11. In addition, the terminal device 12 uses the communication unit 31 to receive the GPS signal for identifying the current position.

The storage unit 32 includes, for example, a semiconductor memory, a magnetic memory, or an optical memory. The storage unit 32 functions, for example, as a main storage device, an auxiliary storage device, or a cache memory. The storage unit 32 stores any information and the control/processing programs used for the operation of the terminal device 12.

The control unit 33 includes, for example, one or more general-purpose processors such as a CPU or a micro processing unit (MPU) or one or more dedicated processors specialized for specific processing. Instead of processors, the control unit 33 may also include one or more dedicated circuits such as an FPGA or an ASIC. The control unit 33 performs operation according to the control/processing programs, or performs operation according to the operation procedure implemented as a circuit, to comprehensively control the operation of the terminal device 12. The control unit 33 sends and receives various types of information to and from other devices such as the server device 10 via the communication unit 31 for performing the operation of the embodiment.

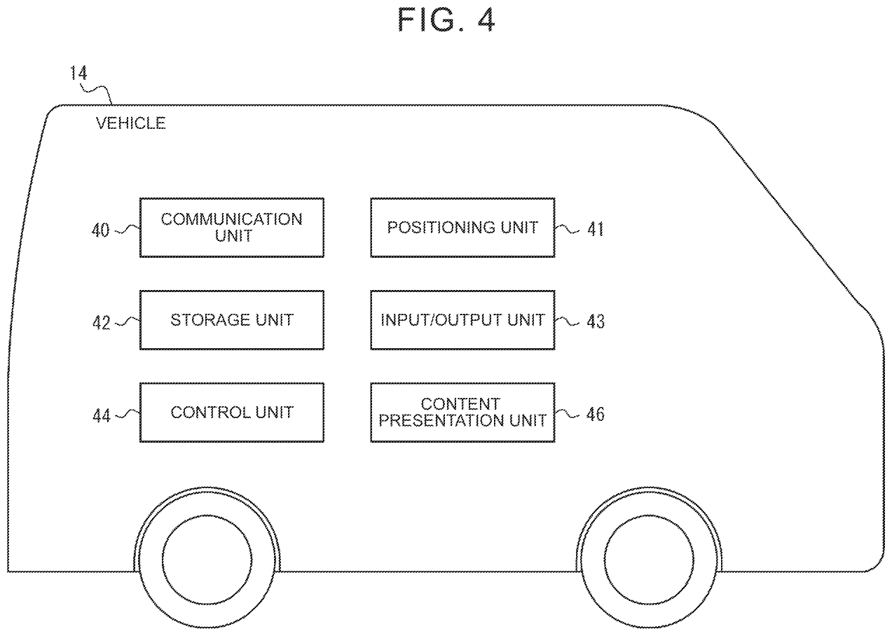

FIG. 4 shows a configuration example of the vehicle 14. The vehicle 14 is a multipurpose vehicle that has a vehicle cabin where necessary equipment can be installed and that can be driven in the manual driving mode or in the manned or unmanned autonomous driving mode. In this embodiment, the vehicle 14 provides the rideshare service for a plurality of spectators of an event. In addition, the vehicle 14 is configured to include a content presentation unit 46. The content presentation unit 46 has a video device and an audio device that present video/voice content to the ride-sharing spectators and has an internal space where the spectators can view the content. The content presentation unit 46 may be managed and operated by a salesperson riding in the vehicle 14 or may be operated unattended.

The vehicle 14 further includes a communication unit 40, a positioning unit 41, a storage unit 42, an input/output unit 43, and a control unit 44. These units are connected to each other, in wired or wireless mode, via an in-vehicle network such as a controller area network (CAN) or via a dedicated line so that they can communicate with each other. A part or all of the communication unit 40, positioning unit 41, storage unit 42, input/output unit 43, and control unit 44 may be provided in the vehicle 14 itself, or may be provided in a control device, such as a car navigation device, that can be removably attached to the vehicle 14. The vehicle 14 may be driven by a driver, or may be autonomously driven at an any autonomous level. The autonomous level is, for example, any of level 1 to level 5 defined by Society of Automotive Engineers (SAE).

The communication unit 40 includes communication modules compatible with the wired or wireless LAN standard and modules compatible with a mobile communication standard such as the 4G standard or the 5G standard. The vehicle 14 is connected to the network 11 by the communication unit 40 via a mobile communication base station for communicating information with other devices over the network 11.

The positioning unit 41 measures the position of the vehicle 14 and generates the position information. The position information, which identifies a position on the map, is the information including coordinates such as two-dimensional coordinates or three-dimensional coordinates. The position information may include not only coordinates but also values indicating the speed, cyclic route, and moving distance or a change in their amounts or a change in rate of those values. The positioning unit 41 includes a receiver compatible with the satellite positioning system. The satellite positioning system supported by the receiver may be, for example, Global Positioning System (GPS). The positioning unit 41 may include an acceleration sensor, a gyro sensor, or several other sensors. Furthermore, a car navigation device may function as the positioning unit 41.

The storage unit 42 includes, for example, a semiconductor memory, a magnetic memory, or an optical memory. The storage unit 42 functions, for example, as a main storage device, an auxiliary storage device, or a cache memory. The storage unit 42 stores any information and the control/processing programs used for controlling the operation of the vehicle 14.

The input/output unit 43 includes an input interface that detects a user input and sends the detected input information to the control unit 44. The input interface is any input interface including, for example, physical keys, capacitive keys, a touch screen integrated with a panel display, various pointing devices, a microphone that receives a voice input, a camera that captures a captured image or an image code, or an IC card reader. In addition, the input/output unit 43 includes an output interface that outputs the information generated by the control unit 44, or the information received from the server device 10, to the user. The output interface is any output interface including, for example, a display that outputs the information as an image/video, a speaker that outputs the information as a voice, or a connection interface for connection to an external output device.

The control unit 44 includes one or more general-purpose processors such as a CPU or an MPU or one or more dedicated processors specialized for specific processing. Instead of processors, the control unit 44 may also include one or more dedicated circuits such as an FPGA or an ASIC. The control unit 44 performs operation according to the control/processing program, or performs operation according to the operation procedure implemented as a circuit, to comprehensively control the operation of the vehicle 14 including the communication unit 40, positioning unit 41, storage unit 42, input/output unit 43, and content presentation unit 46. When the vehicle 14 is autonomously driven, the control unit 44 sends the information necessary for operating the vehicle 14 to the control device that controls autonomous driving. The control unit 44 sends and receives various types of information to and from the server device 10 via the communication unit 40 for performing the operation of the embodiment.

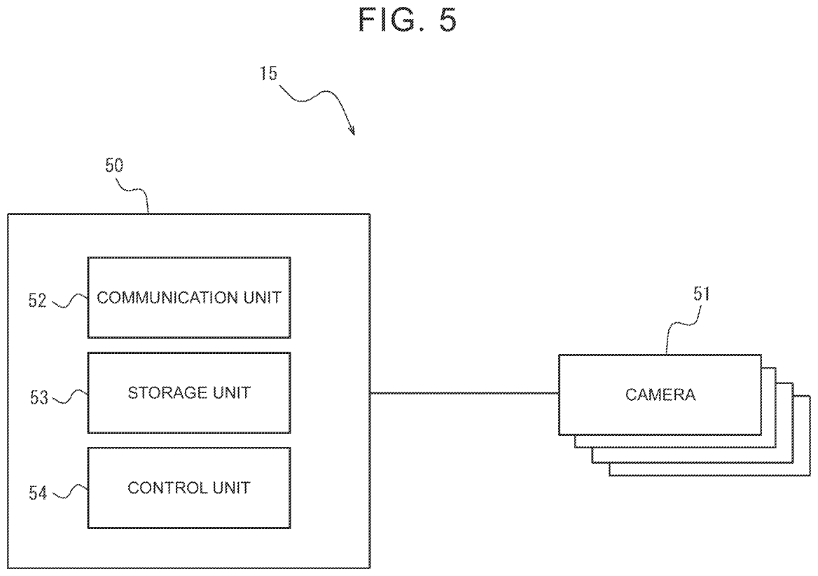

FIG. 5 shows a configuration example of the capturing device 15. The capturing device 15 includes one or more cameras 51 and a control device 50 for controlling the cameras 51. Each camera 51 is installed at any location where the event and/or spectators of the event site can be captured. The one or more cameras 51 capture a general view of the event and the spectators. The camera 51 includes a monocular camera, a stereo camera, or a 360-degree camera. The control device 50 includes a communication unit 52, a storage unit 53, and a control unit 54. The control device 50 is configured by one or more computers that can connect to the network 11 for functioning as an image distribution server.

The communication unit 52 includes communication modules compatible with one or more wired or wireless LAN standards for connection to the network 11. In this embodiment, the capturing device 15 is connected to the network 11 via the communication unit 52 for communicating information with other devices over the network 11.

The storage unit 53 includes, for example, a semiconductor memory, a magnetic memory, or an optical memory. The storage unit 53 functions, for example, as a main storage device, an auxiliary storage device, or a cache memory. The storage unit 53 stores any information and the control/processing programs used for the operation of the capturing device 15.

The control unit 54 includes, for example, one or more general-purpose processors such as a central processing unit (CPU) or one or more dedicated processors specialized for specific processing. Instead of processors, the control unit 54 may also include one or more dedicated circuits such as a field programmable gate array (FPGA) or an application specific integrated circuits (ASIC). The control unit 54 performs operation according to the control/processing programs, or performs operation according to the operation procedure implemented as a circuit, to comprehensively control the operation of the capturing device 15. The control unit 54 sends the captured image of the event and spectators, captured by the capturing device 15, to the server device 10 via the communication unit 52, or receives various types of instructions/information from the server device 10 via the communication unit 52, to perform the operation of this embodiment.

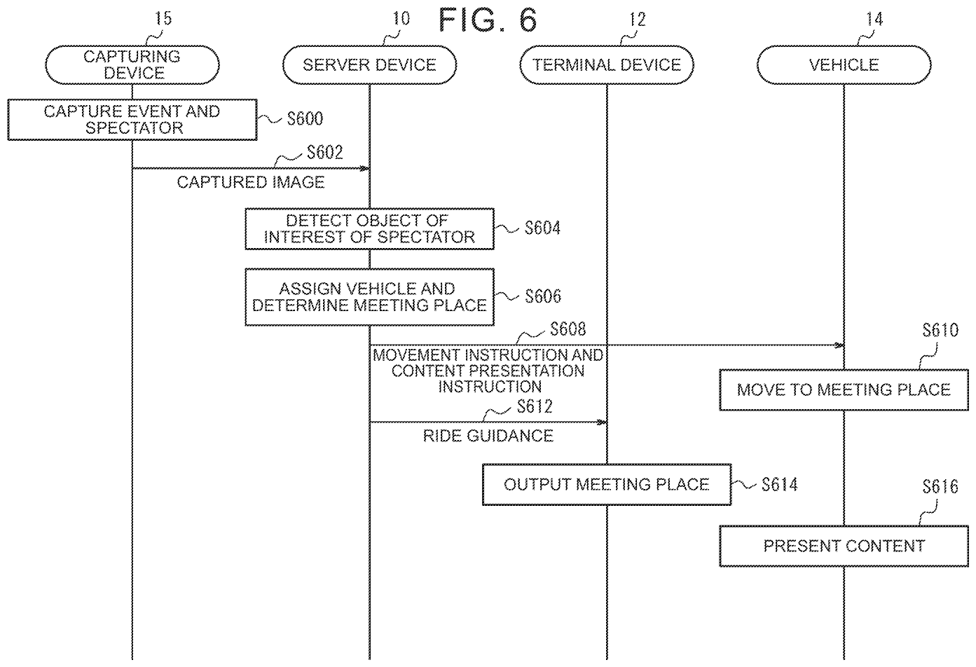

FIG. 6 is a sequence diagram showing an operation example of the information processing system 1. FIG. 6 shows the operation procedure of cooperation among the capturing device 15, server device 10, terminal device 12, and vehicle 14.

When an event is started in an event site, the capturing device 15 captures the event in the event site and the spectators in the spectators' seats in step S600. For example, the control unit 54 of the capturing device 15 causes the cameras 51 to capture the event and the spectators.

In step S602, the capturing device 15 sends the captured images of the event and the spectators to the server device 10. For example, the control unit 54 of the capturing device 15 sends the images, captured by the cameras 51, to the server device 10 via the communication unit 52. Then, the control unit 22 of the server device 10 receives the captured images via the communication unit 20.

In step S604, the server device 10 detects objects of interest of spectators. To do so, the server device 10 performs the following processing. First, the control unit 22 of the server device 10 determines the scenes of the event based on the captured images of the event and stores the type of each scene and the time of occurrence of the scene in the storage unit 21. Examples of scenes of the event include the playing scene of an athlete and the performance scene of a performer. Next, the control unit 22 determines positive reactions of spectators based on the captured image of the spectators and stores the time of occurrence of each reaction in the storage unit 21. Examples of positive reactions of spectators include applause, other delight/excitement gestures, and delight/excitement expressions. The control unit 22 discriminates the scenes of the event and the positive reactions of spectators through image recognition processing. For the image recognition processing for the captured images, any method such as machine learning may be used. After that, the control unit 22 checks the types of scenes of the event against the positive reactions of spectators, for example, according to the time of occurrence. In this way, the control unit 22 detects the objects of interest of the spectators.

An object of interest is, for example, a particular athlete, a particular team, or a particular performer. An object of interest may also be a particular play by a particular athlete or team or a particular performance by a particular performer. When more spectators than a predetermined criterion show a positive reaction in a scene, the control unit 22 detects the object of interest included in the scene. A plurality of objects of interest may be detected in one event. Examples of an object of interest include athlete A himself, the play of athlete A after m minutes have elapsed, sport team B itself, the moment when the victory of team B is determined, performer C himself, and the performance of performer C after n minutes have elapsed.

In step S606, the server device 10 assigns the vehicle 14 to a plurality of spectators sharing an object of interest that has been detected and, in addition, determines the meeting place for riding in the assigned vehicle 14. The control unit 22 of the server device 10 assigns the vehicle 14, for example, to each of the following groups: a plurality of spectators who showed a positive reaction to the play of athlete A after m minutes have elapsed, a plurality of spectators who showed a positive reaction to the attack of team B, a plurality of spectators who showed a positive reaction to the play of performer C after n minutes have elapsed. Any method may be used to assign the vehicle 14 to a group of spectators. For example, the control unit 22 assigns the vehicle 14 having a capacity corresponding to the number of spectators of a group of spectators or assigns the vehicle 14 located relatively near to the event site indicated by the position information acquired from the vehicle 14. After that, the control unit 22 arbitrarily determines the meeting place of each group of spectators. The control unit 22 acquires the guidance information on the event site in advance from the website operated by the event organizer and determines, for example, an entrance/exit number of the event site, an intersection near to the event site, or any other location as the meeting place. When the spectators' seats in the event site are separated by the supporting team, the control unit 22 may determine the entrance/exit near to that spectators' seats as the meeting place of a group of spectators that showed a positive reaction to the play of the supporting team.

In step S608, the server device 10 sends two instructions to each vehicle 14: one is the movement instruction for moving each vehicle 14 to the meeting place and the other is the content presentation instruction for causing the vehicle 14 to present the content corresponding to the object of interest. The control unit 22 of the server device 10 sends the movement instruction and the content presentation instruction to the vehicle 14 via the communication unit 20. In addition, the control unit 22 may acquire the position information from the vehicle 14 and, based on the position of the vehicle 14, specify an expected time at which the vehicle 14 will arrive at the meeting place. As an example, the control unit 22 may predict the end time of the event based on the captured image and may set the time immediately after the end time of the event (for example, three to five minutes after the end time of the event), as the estimated arrival time considering the traveling time of the vehicle 14. The control unit 44 of the vehicle 14 receives the movement instruction and the content presentation instruction via the communication unit 40.

In step S610, the control unit 44 of the vehicle 14 controls the vehicle 14 to move to the meeting place according to the movement instruction. For example, the control unit 44 uses the display of the input/output unit 43 to output the position of the meeting place and its location for instructing the occupant of the vehicle 14 to move to that position. When the vehicle 14 is autonomously driven, the control unit 44 sends an instruction to the autonomous driving control device of the vehicle 14 to instruct the control device to move the vehicle 14 to toward the meeting place. When an arrival time is specified by the movement instruction, the movement start time and the movement speed of the vehicle 14 are controlled so that the vehicle 14 can arrive at the meeting place at the specified time.

In step S612, the server device 10 sends the ride guidance to the terminal device 12. The ride guidance is the information that notifies the spectator about the meeting place for each group of spectators sharing the object of interest and prompts the spectator to ride in the vehicle 14. The control unit 22 of the server device 10 sends the ride guidance to the terminal device 12 via the communication unit 20. The control unit 33 of the terminal device 12 receives the ride guidance via the communication unit 31. The ride guidance includes the object of interest, the identification information such as the vehicle number of the vehicle 14 assigned to the group of spectators sharing the object of interest, and the meeting place for riding in the vehicle 14. In addition, the ride guidance may include the arrival time of the vehicle 14 or the scheduled ride time determined arbitrarily based on the arrival time. For example, the ride guidance includes the information such as the vehicle number, the meeting place, and the scheduled ride time determined for the fans of athlete A, the information such as the vehicle number, the meeting place, and the scheduled ride time determined for the supporters of team B, or the information such as the vehicle number, the meeting place, and the scheduled ride time determined for the fans of performer C.

In step S614, the terminal device 12 outputs the ride guidance. The control unit 33 of the terminal device 12 uses the input/output unit 30 to output, by display or voice, the object of interest, the identification information on the vehicle 14, the meeting place, and the scheduled ride time based on the ride guidance. The ride guidance that is output in this way allows the spectator, who uses the terminal device 12, to recognize the identification information on the vehicle 14 corresponding to his or her own object of interest, the meeting place, and the scheduled ride time. For example, when the spectator is a fan of athlete A, he or she can recognize the vehicle number, meeting place, and scheduled ride time determined for the fans of athlete A; when the spectator is a supporter of team B, he or she can recognize the vehicle number, meeting place, and scheduled ride time determined for the supporters of team B; and when the spectator is a fan of performer C, he or she can recognize the vehicle number, meeting place, and scheduled ride time determined for the fans of performer C. Then, after the event is ended, the spectator moves to the recognized meeting place by the scheduled ride time. As an example, the control unit 22 determines the end time of the event from the captured image and, when or immediately after the event is ended (for example, in 3 to 5 minutes after the event is ended), sends the ride guidance to the terminal device 12. This will allow the spectators to move to the meeting place without delay.

In step S616, when the spectators ride in the vehicle 14 at the meeting place, the control unit 44 of the vehicle 14 causes the vehicle 14 to present the content in response to the content presentation instruction. For example, the control unit 44 sends the instruction, which presents the content of the object of interest, to the control device of the content presentation unit 46 to cause the content presentation unit 46 to present the content. The content for the object of interest is, for example, the video/audio of a playing scene of athlete A or team B or a performance scene of performer C. The content for the object of interest is delivered, for example, from the server device 10. When the content is received via the communication unit 40, the control unit 44 of the vehicle 14 sends the received content to the content presentation unit 46. Then, the content presentation unit 46 presents the content to the spectators riding in the vehicle 14. The content may be presented while the vehicle 14 is stopped or while the vehicle 14 moves. For example, the vehicle 14 keeps presenting the content while traveling around the destinations of the spectators as requested by the spectators in the vehicle. This means that, on the way back from the event site, the spectator can ride-share the vehicle 14 with other spectators who share the object of interest and, at the same time, can view the content related to the common object of interest. For example, since the ride-sharing spectators can together view the video and audio of a playing scene of a favorite athlete or team or of a performance scene of a favorite performer, the fun of ride sharing can be increased.

In another example, the control unit 33 of the terminal devices 12 sends the position information on the terminal device 12 to the server device 10 to allow the control unit 22 of the server device 10 to acquire the position of the terminal device 12 in the event site. Then, the control unit 22 of the server device 10 sends the capturing instruction to the capturing device 15 in the event site, with the position of the terminal device 12 specified, to instruct the capturing device 15 to capture the spectator. When the capturing instruction is received via the communication unit 52, the control unit 54 of the capturing device 15 captures, in step S600, the range including the specified position of the specified spectator's seat. In this case, the control unit 22 of the server device 10 can use the captured image of each of the spectators, who use the terminal device 12, to detect the object of interest of the spectator. Therefore, when sending the ride guidance to the terminal device 12 in step S612, the server device 10 can send the ride guidance including the information corresponding to each spectator, that is, the ride guidance including the identification information on the vehicle 14 in which the spectators sharing the object of interest with the spectator are to ride, the meeting place, and the scheduled ride time. This makes it possible for the spectator to reduce the complication that the spectator receives the ride guidance about an object of interest different from that of the spectator and, as a result, the spectator has to determine the vehicle 14 in which to ride that corresponds to his or her own object of interest.

The control unit 22 of the server device 10 may determine the meeting place based on the position of the terminal device 12. For example, as the meeting place, the control unit 22 of the server device 10 may determine a place that is relatively near to the terminal device 12 to make it possible to improve the convenience of the spectator that uses the terminal device 12. In addition, the control unit 22 of the server device 10 may determine the meeting place using not only the position information on the terminal device 12 but also the position information on the vehicle 14. For example, as the meeting place, the control unit 22 may determine a place where the sum of the distance from the terminal device 12 and the distance from the vehicle 14 is minimized. Determining the meeting place in this way makes it possible to optimize the time required for the spectator to arrive at the meeting place and the time required for the vehicle 14 to arrive at the meeting place.

In addition, when detecting the object of interest of a spectator, the control unit 22 of the server device 10 may use the information indicating the physical condition of the spectator, acquired from the terminal device 12, as the information about the state of the spectator in addition to or in place of the captured images. For example, the terminal device 12 acquires the information indicating the physical condition, such as the heart rate and the blood pressure of the spectator, from a wearable device such as a wristwatch worn by the spectator and, then, sends the acquired information to the server device 10 together with the identification information and the position information on the terminal device 12. In this case, the control unit 22 of the server device 10 determines that a positive reaction is detected when a heart rate or a blood pressure equal to or higher than a given value is detected. In addition to using the captured image of a spectator who has been identified based on the position information, the server device 10 uses the information indicating the physical condition acquired from the terminal device 12 that has the identification information associated with the position information. Using the information indicating the physical condition as described above allows the server device 10 to detect the object of interest of the spectator more accurately.

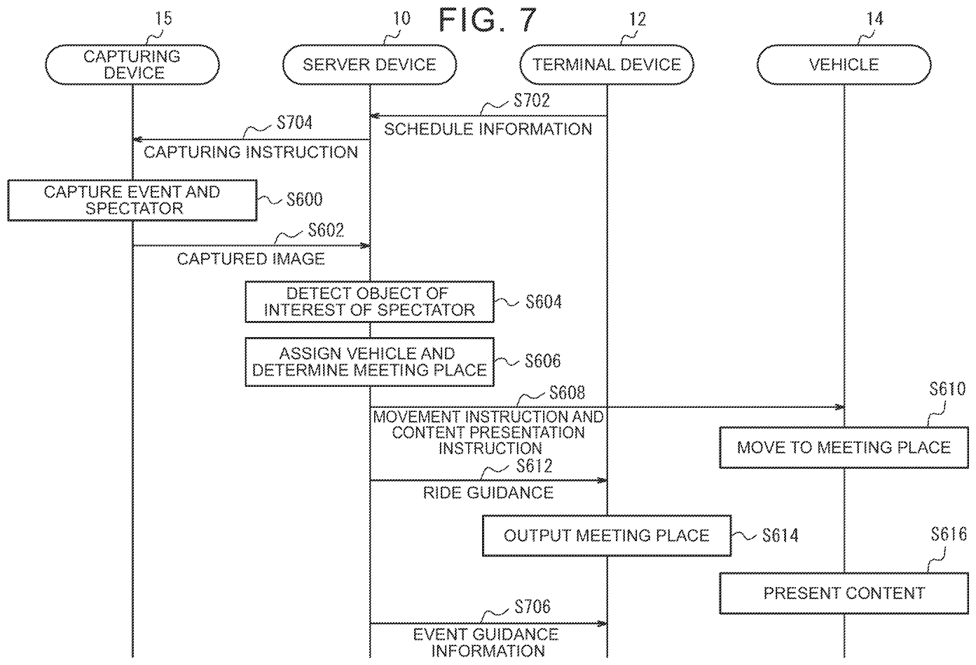

FIG. 7 is a sequence diagram showing another operation example of the information processing system 1. FIG. 7 shows the operation procedure of the cooperative operation performed by the capturing device 15, server device 10, terminal device 12, and vehicle 14. In the procedure shown in FIG. 7, steps S702 to S704 are added before the procedure shown in FIG. 6 (that is, steps S600 to S616) and step S706 is added after the procedure shown in FIG. 6.

In step S702, a spectator operates the terminal device 12 and sends to the server device 10 the schedule information on an event that the spectator is scheduled to watch. The control unit 33 of the terminal device 12 accepts the spectator's schedule information from the input/output unit 30 and sends the accepted schedule information to the server device 10 via the communication unit 31. The control unit 22 of the server device 10 receives the schedule information via the communication unit 20. For example, the spectator uses the terminal device 12 to access the schedule management website, provided by the server device 10, and enters the schedule information. The schedule information includes the event identification information such as the event name, the date and time of the event, the site of the event, and the information indicating the spectator's seat reserved by the spectator.

In step S704, when the event is held, the server device 10 sends the capturing instruction to the capturing device 15 provided in the corresponding event site. This capturing instruction specifies the position of the spectator's seat to be captured and instructs the capturing device 15 to capture the spectator. The control unit 22 of the server device 10 generates the capturing instruction, which includes the position of the spectator's seat, and sends the capturing instruction to the capturing device 15 via the communication unit 20. When the capturing instruction is received via the communication unit 52, the control unit 54 of the capturing device 15 captures the event and the spectator in the spectator's seat in step S600. After that, steps S604 to S616 are performed.

In step S706, the server device 10 sends the event guidance information, which is the information about an event that will be held at a later date, to the terminal device 12. The control unit 22 of the server device 10 stores the object of interest of the spectator of the terminal device 12 in the storage unit 21 in advance. When an event schedule corresponding to the object of interest of the spectator is acquired from another server device operated by the event organizer, the control unit 22 of the server device 10 sends the event guidance information, which notifies about the event, to the terminal device 12. This event guidance information allows the spectator to obtain more reliably the event information including the object of interest of the spectator, thus increasing the convenience of the spectator. In addition, when the event is held, the server device 10 may instruct the vehicle 14 to travel towards the event site while sequentially picking up spectators who share the object of interest and, at the same time, to present the content of the common object of interest to the spectators while traveling to the event site. Doing so allows the spectators to enjoy the topic of the common object of interest or to enjoy content-viewing during the time of traveling to the event site, making it possible to increase the fun of ride sharing until the vehicle 14 arrives at the event site.

According to this embodiment, spectators who share an object of interest can ride-share with each other as described above. In addition, in the vehicle 14, the spectators can view the content related to the common object of interest, increasing the fun of ridesharing.

In the above embodiment, the processing/control program that defines the operation of the control unit 33 of the terminal device 12 may be stored in the storage unit 21 of the server device 10 or in the storage unit of another server device and, from the storage unit, the program may be downloaded to each terminal device via the network 11. Instead of this, the processing/control program may be stored in a portable, non-transitory recording/storage medium that is readable by each terminal device and, from the medium, the program may be read by each terminal device. Similarly, the processing/control program that defines the operation of the control unit 44 of the vehicle 14 may be stored in the storage unit 21 of the server device 10 or in the storage unit of another server device and, from the storage unit, the program may be downloaded to the storage unit 42 of the vehicle 14 over the network 11. Instead of this, the processing/control program may be stored in a portable, non-transitory recording/storage medium that is readable by the control unit 44 and, from the medium, the program may be read by the control unit 44.

Although the embodiment has been described with reference to the drawings and examples, it should be noted that those skilled in the art can easily make various changes and modifications based on the present disclosure. Therefore, it is to be noted that these changes and modifications are within the scope of the present disclosure. For example, it is possible to relocate the functions included in each unit or each step in such a way that they are not logically contradictory, and it is possible to combine a plurality of units or steps into one or to divide them.

What is claimed is:

1. A server device comprising:
a communication unit; and
a control unit configured to send and receive information to and from another device via the communication unit, wherein the control unit is configured to detect an object of interest of a spectator based on a state of the spectator detected during execution of an event and is configured to send a notification to prompt to ride in a vehicle to a plurality of terminal devices respectively used by a plurality of spectators, the vehicle being a vehicle assigned to the plurality of spectators sharing the object of interest.

2. The server device according to claim 1, wherein the control unit is configured to send the notification to prompt to ride in the vehicle to the plurality of terminal devices with a meeting place specified and is configured to send an instruction to move to the meeting place to the vehicle.

3. The server device according to claim 1, wherein the control unit is configured to send to the vehicle an instruction to present content to the plurality of spectators, the content corresponding to the object of interest.

4. The server device according to claim 2, wherein the control unit is configured to receive first position information from the terminal device and is configured to determine the meeting place based on the first position information, the first position information indicating a position of the terminal device.

5. The server device according to claim 4, wherein the control unit is configured to receive second position information from the vehicle and is configured to determine the meeting place considering the second position information, the second position information indicating a position of the vehicle.

6. The server device according to claim 1, wherein the control unit is configured to receive information from the plurality of terminal devices and is configured to detect an object of interest of the plurality of spectators considering the information, the information indicating physical conditions of the plurality of spectators.

7. The server device according to claim 4, wherein the control unit is configured to send an instruction to a capturing device provided in a site of the event based on the first position information, the instruction indicating a position to be captured.

8. The server device according to claim 1, wherein the control unit is configured to send event guidance information to the terminal device, the event guidance information being related to the object of interest.

9. An information processing system comprising the server device and the vehicle according to claim 1.

10. A control device mounted on a vehicle, the control device being configured to send and receive information to and from a server device and, at the same time, to control the vehicle, wherein, when an instruction to move to a meeting place of a plurality of spectators is sent from the server device, the control device is configured to control the vehicle to move to the meeting place, the server device being configured to detect an object of interest of a spectator based on a state of the spectator detected during execution of an event and being configured to send a notification to prompt to ride in a vehicle to a plurality of terminal devices respectively used by a plurality of spectators, the vehicle being a vehicle assigned to the plurality of spectators sharing the object of interest.

11. The control device according to claim 10, wherein, when an instruction to present content to the spectator is received from the server device, the control device is configured to output an instruction to present the content, the content corresponding to the object of interest.

12. A program that, when executed by a control device of a vehicle, causes the control device to perform an operation as the control device according to claim 10.

13. A vehicle comprising the control device according to claim 10.

14. A program executed by a terminal device that communicates with a server device and is capable of inputting and outputting information, wherein, when executed by the terminal device, the program causes the terminal device to perform an operation as the terminal device according to claim 1.

15. An operation method of an information processing system including a server device and a vehicle that communicates with the server device, the operation method comprising:
the server device
detecting an object of interest of a spectator based on a state of the spectator detected during execution of an event;
sending a notification to prompt to ride in a vehicle to a plurality of terminal devices respectively used by a plurality of spectators, the vehicle being a vehicle assigned to the plurality of spectators sharing the object of interest; and
sending an instruction to move to a meeting place of the plurality of spectators to the vehicle; and
the vehicle moving to the meeting place.

16. The operation method according to claim 15, wherein:
the server device sends to the vehicle an instruction to present content to the plurality of spectators, the content corresponding to the object of interest; and
the vehicle presents the content to the plurality of spectators.

17. The operation method according to claim 15, wherein the server device receives first position information from the terminal device and determines the meeting place based on the first position information, the first position information indicating a position of the terminal device.

18. The operation method according to claim 17, wherein:
the vehicle sends second position information to the server device, the second position information indicating a position of the vehicle; and
the server device determines the meeting place considering the second position information.

19. The operation method according to claim 15, wherein the server device receives information from the plurality of terminal devices and detects an object of interest of the plurality of spectators considering the information, the information indicating physical conditions of the plurality of spectators.

20. The operation method according to claim 17, wherein the server device sends an instruction to a capturing device provided in a site of the event based on the first position information, the instruction indicating a position to be captured.
